(19) United States
(12) Patent Application Publication
(10) Pub. No.: US 2026/0264214 A1
(43) Pub. Date: Sep. 10, 2026

(54) Gripping Device as Assistive Tool

(71) Applicant: FORM5 PROSTHETICS, INC., Westerville, OH (US)

(72) Inventors: Aaron WESTBROOK, Reynoldsburg, OH (US); Gregory THUNE, Westerville, OH (US); Todd BEMIS, Atlanta, GA (US); Charlie BALDWIN, Columbus, OH (US); Aidan ODDLOKKEN, St. Rose, LA (US); Bridget BURKE, Worthington, OH (US); Kaya CAPRETTA, Galion, OH (US); David CRUISE, Powell, OH (US); Jenny LI, Strongsville, OH (US); Emily SALINGS, Blacklick, OH (US); Madden VANGSNESS, Columbus, OH (US); Oren SHAI, Westerville, OH (US); Amy CRUISE, Powell, OH (US)

(21) Appl. No.: 19/560,963

(22) Filed: Mar. 9, 2026

Related U.S. Application Data
(60) Provisional application No. 63/769,144, filed on Mar. 9, 2025.

(51) Int. Cl. B25J 1/04

(52) U.S. Cl. CPC B25J 1/04

(57) ABSTRACT

A gripping device includes a forward handle member and a rear handle member joined by a pivot joint and biased toward a normally open position by a biasing member disposed about the pivot joint. Opposing jaws extend distally from respective ones of the handle members, the opposing jaws defining a longitudinal jaw axis forming an obtuse angle relative to a longitudinal axis of the handle members. In certain embodiments, the biasing member comprises a torsion spring concentrically disposed about a pivot axis of the pivot joint. At least one of the opposing jaws may include a jaw main body and a distal jaw section having a reduced cross-sectional portion configured to receive a removable distal gripping module. The distal gripping module may include an internal cavity and may provide alternative gripping geometries. The handle members may include ergonomic curvature and an integrally formed finger hook positioned between the pivot joint and a lower jaw. The gripping device may further include textured or elastomeric gripping surfaces, a magnet seat, an assistive cuff, and a flexible retention loop.

### CROSS-REFERENCE TO RELATED APPLICATION

The present application claims benefit of U.S. provisional Application No. 63/769,144 filed Mar. 9, 2025, the entire contents of which are incorporated herein by reference.

### BACKGROUND OF THE INVENTION

### Field of the Invention

The present invention relates generally to hand-operated gripping devices and assistive tools, and more particularly to compact gripping devices configured to assist with manipulation of small objects, well-suited for individuals with arthritis, neuromuscular conditions and related fine-motor disabilities.

### Description of the Related Art

Various plier-type gripping tools are known. Such tools typically include two handle members joined at a pivot, with opposing jaws extending forwardly from the pivot. In many conventional plier configurations, the jaws are arranged substantially along or parallel to a longitudinal axis of the handle members, such that the gripping direction is generally axial relative to the handle orientation. These tools are commonly designed to apply compressive force for gripping, bending, or cutting operations and are generally configured for strength and mechanical leverage rather than precision manipulation of small, delicate objects.

A variety of object-retrieval and assistive gripping devices are also known in the art. Many commercially available devices are configured as elongated reacher tools designed to extend a user's reach and provide leverage for grasping objects positioned at a distance. Closure of the jaws is commonly achieved through cable-driven or linkage-based actuation mechanisms extending through the shaft. These reacher devices are generally optimized for extending reach and increasing lifting leverage. The gripping jaws are typically broad and sized to engage medium-to-large objects such as containers, clothing, household items, or other objects that require gross-motor gripping.

While such devices are effective for extending reach and lifting larger objects, their structural configurations are not primarily directed toward fine-motor manipulation. The relatively large gripping surfaces may limit the ability to isolate small objects. Additionally, the actuation mechanisms are typically designed to generate sufficient force for lifting or holding larger items, rather than to provide controlled, low-force, pinch-style articulation.

As a result, tasks involving small, thin, or delicate objects, such as keys, coins, pills, paper items, beads, puzzle pieces, zipper pulls, safety pins, or similar household objects, may present challenges when using conventional reacher-type devices. The mechanical architecture of many known assistive gripping tools emphasizes leverage and grip strength rather than precision positioning or fine tactile control.

Accordingly, there remains a need in the art for a gripping device configured to facilitate controlled manipulation of small objects while providing assistive functionality for users with limited hand strength or dexterity.

### SUMMARY OF THE INVENTION

The present disclosure provides a gripping device configured to facilitate controlled manipulation of small objects while providing assistive functionality for users with reduced hand strength or dexterity.

The compact form of the device permits portability and use in a variety of environments where fine manipulation is required, including household tasks, personal care activities, crafts, and other applications involving small objects.

In one embodiment, the gripping device includes a forward handle member and a rear handle member joined by a pivot joint and biased toward a normally open position by a biasing member disposed about the pivot joint. Opposing jaws extend distally from respective ones of the handle members. The opposing jaws define a longitudinal jaw axis forming an obtuse angle relative to a longitudinal axis of the handle members. This angular relationship permits controlled pinch-type articulation suitable for fine-motor manipulation of small or delicate objects.

Accordingly, comprehended is a gripping device, comprising: a forward handle member; a rear handle member; a pivot joint joining the forward handle member and the rear handle member; a biasing member such as a torsion spring disposed about the pivot joint, the biasing member configured to bias the forward handle member and the rear handle member toward a normally open position; opposing jaws extending distally from respective ones of the forward handle member and the rear handle member, wherein the opposing jaws define a longitudinal jaw axis, wherein the longitudinal jaw axis forms an obtuse angle relative to a longitudinal axis of the forward handle member and the rear handle member.

In further embodiments, the opposing jaws are configured and toleranced to be in continuous contact along at least a portion of their length between the pivot joint and their respective termini at the distal jaw section of the device, the contact configured to serve as a torque limiter to prevent over gripping of the jaws on a target object.

In further embodiments, the forward handle member includes an ergonomic curvature and may incorporate an integrally formed finger hook positioned between the pivot joint and a lower jaw. The finger hook and associated arcuate body portion of the forward handle member may define a concave engagement region configured to receive a user's finger. The rear handle member may be substantially linear. In some configurations, an inwardly projecting raised portion formed on an inner surface of the rear handle member is configured to abut an opposing surface of the forward handle member to limit rotational closure and thereby serve as a torque limiter to prevent over gripping of the jaws on a target object.

In certain embodiments, at least one of the opposing jaws includes a removable distal gripping module mounted over a reduced cross-sectional portion of the distal jaw section. The removable distal gripping module may comprise a discrete body including an internal cavity configured to receive the distal jaw section, thereby permitting modification of the distal gripping geometry. Alternative gripping geometries may be provided for retaining small objects such as wires, screws, beads, or other detailed components.

In some embodiments, at least one of the opposing jaws includes a recessed portion defined in a lateral surface of a jaw body to reduce material mass while maintaining structural integrity along a gripping edge.

In additional embodiments, at least one of the opposing jaws includes an over-molded elastomeric sleeve or textured gripping surface to enhance frictional engagement and reduce slippage when manipulating small or smooth objects.

The gripping device may further include an assistive cuff coupled to one or both handle members to stabilize actuation and distribute force across a portion of a user's hand. A flexible retention loop may also be provided to maintain the opposing jaws in a closed position when desired.

### BRIEF DESCRIPTION OF THE DRAWINGS

FIG. 1 is a left-side view of a gripping device in accordance with an exemplary embodiment, shown in a normally open position.

FIG. 2 is a front view of the gripping device of FIG. 1.

FIG. 3 is a top elevation view of the gripping device of FIG. 1.

FIG. 4 is a right-side view of the gripping device of FIG. 1.

FIG. 5 is a bottom elevation view of the gripping device of FIG. 1.

FIG. 6 is a rear elevation view of the gripping device of FIG. 1.

FIG. 7 is an exploded perspective view of the gripping device.

FIG. 8 is an exploded view showing the fastener, washers, and torsion spring.

FIG. 9 is a perspective view thereof.

FIG. 10 is a perspective view of an embodiment including over-molded elastomeric gripping surfaces as part of the grip modules.

FIG. 11 is an exploded view thereof.

FIG. 12 is a perspective view of an embodiment including gripping projections as part of the textured surface.

FIG. 13 is an exploded view thereof.

FIG. 14 is a perspective view of an embodiment including a removable distal gripping module.

FIG. 15 is an exploded perspective view thereof.

FIGS. 16-21 show perspective views of various embodiments of distal gripping module geometry.

FIG. 22 is a perspective view of an embodiment including an assistive cuff coupled to a handle member.

FIG. 23 is a perspective view of the assistive cuff.

FIG. 24 is a perspective view of an embodiment showing alternative configurations of the distal gripping modules reduced cross-section portions.

FIGS. 25-26 show perspective views of various configurations of distal gripping modules thereof.

FIG. 27 shows an exploded view in partial cut-off showing an embodiment with the distal ends extended.

### DETAILED DESCRIPTION OF THE PREFERRED EMBODIMENT

Reference will now be made in detail to embodiments disclosed herein. Where appropriate, like reference terminology is used consistently with the claims. The embodiments described are illustrative and not limiting.

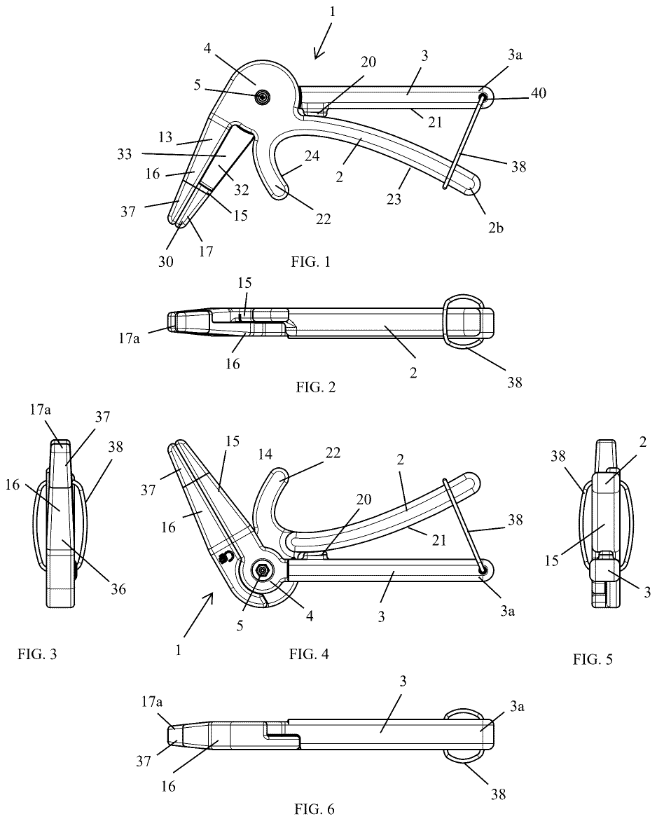

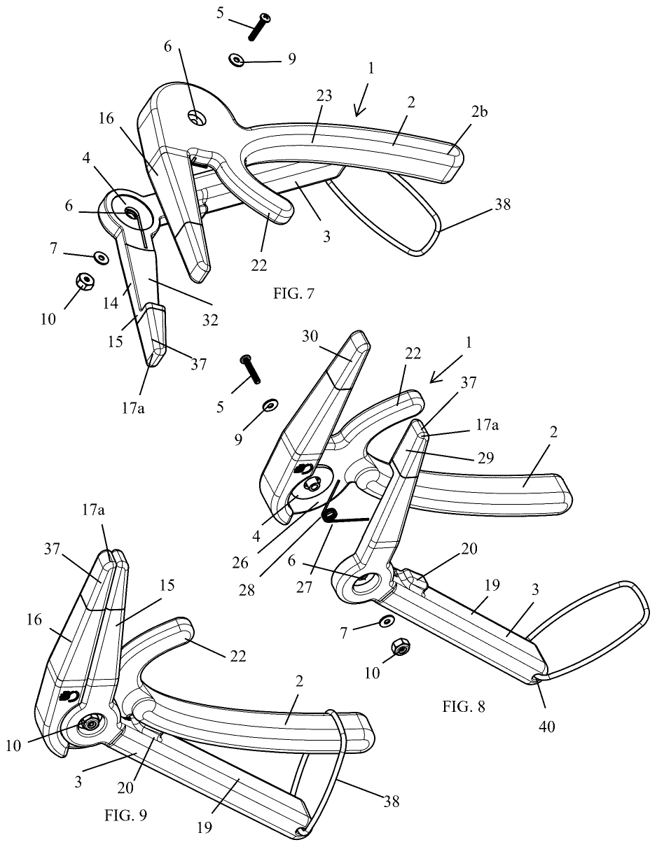

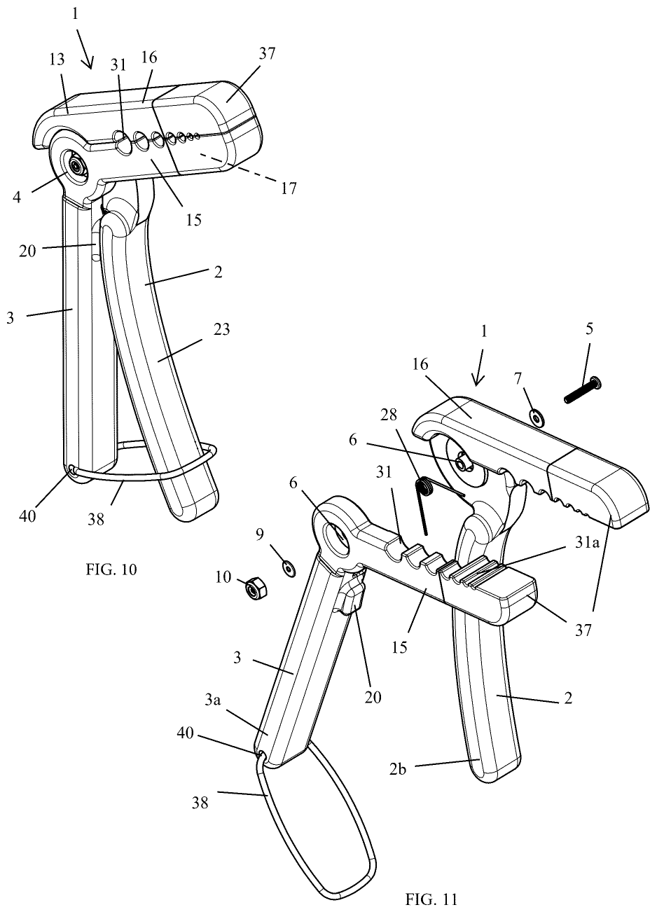

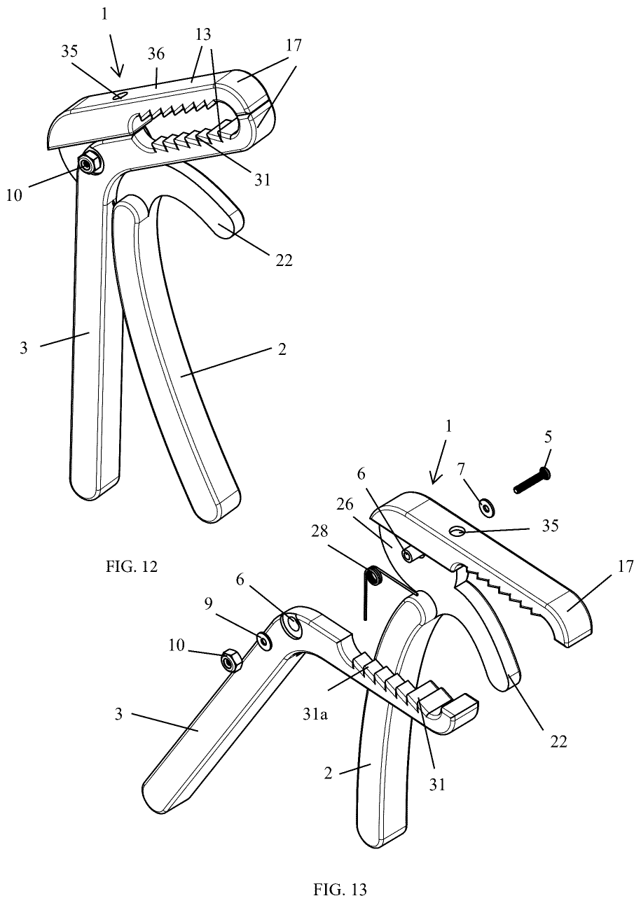

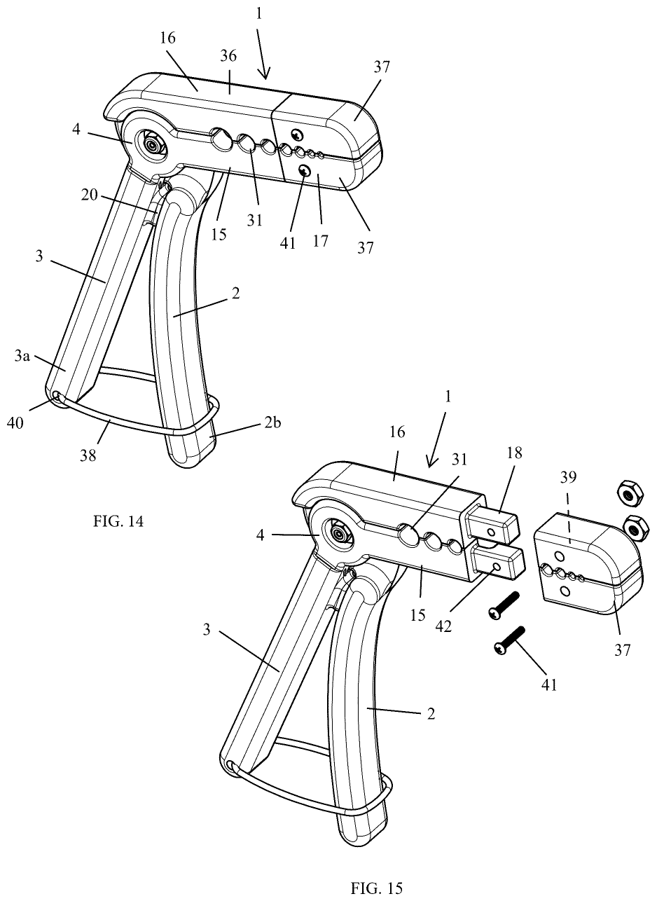

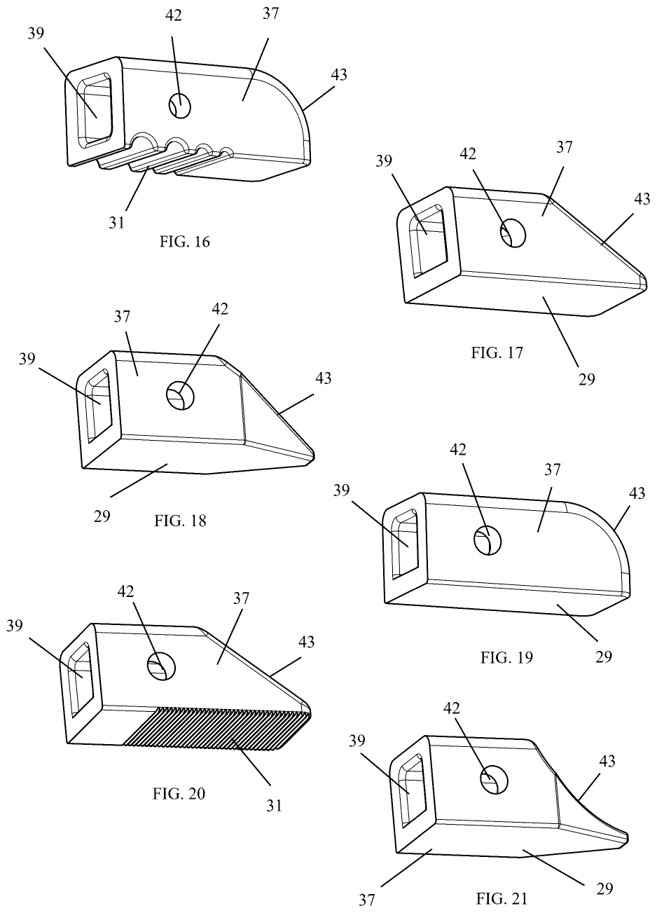

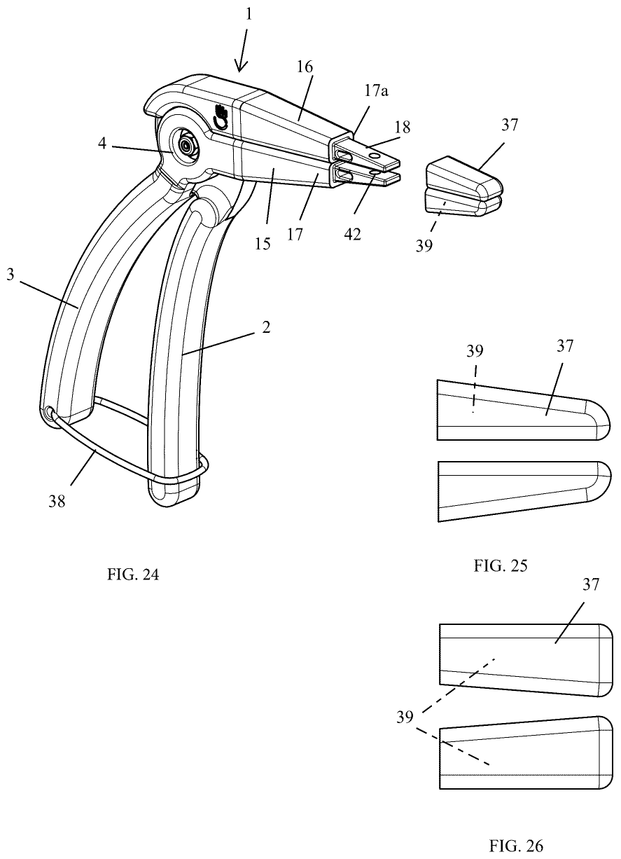

Referencing then FIG. 1-27, in an exemplary embodiment the instant gripping device 1 includes a forward handle member 2 and a rear handle member 3 joined by a pivot joint 4. In certain embodiments, the forward handle member 2 transitions continuously into the upper jaw 16 without a discrete intermediate head portion. In such embodiments, the upper jaw 16 may be integrally formed as a continuous extension of the forward handle member 2. The transition between the forward handle member 2 and the upper jaw 16 may be smooth or contoured and may include a gradual change in cross-sectional geometry. Similarly, in certain embodiments, the rear handle member 3 may transition integrally into the lower jaw 15.

In alternative embodiments, one or both of the opposing jaws 13 may be formed as separate components secured to the corresponding handle member. Here, the forward handle member 2 preferably includes an arcuate body portion 25 positioned between the pivot joint 4 and a lower jaw 15 of the opposing jaws 13.

Preferably, the forward handle member 2 and the rear handle member 3 are formed from lightweight materials to reduce overall device mass and user fatigue during repeated use. Suitable materials may include polymeric materials such as molded plastics, fiber-reinforced composites, or similar lightweight structural materials. In some embodiments, the handle members 2, 3 may alternatively be formed from lightweight metals, including aluminum or aluminum alloys.

A biasing member 12 is disposed about the pivot joint 4 and is configured to bias the forward handle member 2 and the rear handle member 3 toward a normally open position. Opposing jaws 13 extend distally from respective ones of the forward handle member 2 and the rear handle member 3. Opposing jaws 13 are defined by a lower jaw 15 and an upper jaw 16. In combination, the opposing jaws 13 define a longitudinal jaw axis that forms an obtuse angle relative to a longitudinal axis of the forward handle member 2 and the rear handle member 3. Note “obtuse” means the aforementioned longitudinal axis is preferably not ninety (90) degrees relative to the handle members 2, 3 while also not one hundred eighty (180) degrees, i.e., not axially aligned relative to handle members 2, 3. This angular configuration facilitates controlled pinch-style manipulation of small objects.

In certain embodiments, the biasing member 12 comprises a torsion spring 28 concentrically disposed about a pivot axis of the pivot joint 4. The pivot axis, and so too the spring axis of torsion spring 28, is substantially orthogonal to the longitudinal jaw axis defined by jaws 13. Said another way, torsion spring 28 is concentrically disposed about the pivot axis of pivot joint 4 such that a spring axis of the torsion spring 28 is coaxial with the pivot axis. To assemble, the pivot joint 4 may include a fastener 5 extending through aligned apertures 6 of the forward handle member 2 and the rear handle member 3. For example, a first washer 7 is positioned adjacent a head 8 of the fastener 5 and a second washer 9 is positioned adjacent a nut 10 secured to the fastener 5. A third washer 11 is disposed between the forward handle member 2 and the rear handle member 3 and is adapted to abut the torsion spring 28. The fastener 5 may apply axial compression to retain the torsion spring 28 and the third washer 11 in fixed axial alignment between the handle members 2, 3. The torsion spring 28 is selected to provide controlled incremental closure of the opposing jaws 13 in response to manual compression of the forward handle member 2 and the rear handle member 3. The biasing characteristics of the torsion spring 28 may be configured to permit low-force actuation suitable for manipulation of small or delicate objects while maintaining sufficient closing force for secure retention.

In some embodiments, the rear handle member 3 is substantially linear, while the forward handle member 2 includes an ergonomic curvature 23. As used herein, the term “substantially” in all instances is intended to denote approximation consistent with normal manufacturing tolerances, material deformation under load, and functional performance of the device. By way of example, “substantially linear” includes configurations that are generally straight but may include minor curvature or deviation that does not materially affect the functional alignment of the component. Similarly, “substantially orthogonal” includes orientations that are generally perpendicular, recognizing that exact ninety-degree alignment is not always possible and minor angular variation may be present. Unless otherwise expressly stated, directional and geometric descriptors are intended to describe configuration rather than precise mathematical relationships. The rear handle member 3 may also be curved.

As above, the forward handle member 2 may include an arcuate body portion 25 positioned between the pivot joint 4 and a lower jaw 15 of the opposing jaws 13. The arcuate body portion 25 may define a concave inwardly facing contour forming structural base 26 from which the finger hook 22 extends, thereafter configured to receive a user's finger. This finger hook 22 may also extend integrally from the forward handle member 2 between the pivot joint 4 and the lower jaw 15. The finger hook 22 includes a curved profile 24 having opposite concavity relative to the ergonomic curvature 23 of the forward handle member 2. An inner surface 19 of the rear handle member 3 may include an inwardly projecting raised portion 20 configured to abut an opposing interior surface 21 of the forward handle member 2 to limit rotational closure of the handle members and thereby serve as a torque limiter to prevent over gripping of the jaws on a target object.

The opposing jaws 13 include an upper jaw 16 and a lower jaw 15. In certain embodiments, the opposing jaws 13 comprise substantially flat gripping surfaces 29 suitable for precision manipulation of small objects. At least one of the opposing jaws 13 may include a recessed portion 32 defined in a lateral surface 33 thereof. The recessed portion 32 may be centrally positioned within a jaw body 14 and may extend longitudinally along at least a portion of the jaw body 14. In this manner the weight of the gripping device 1 can be lessened. The recessed portion 32 may provide clearance during pivoting motion of the corresponding jaw 15, 16. In particular, as the lower jaw 15 rotates about pivot joint 4 toward the upper jaw 16, the recessed portion 32 permits controlled inward travel of the jaw body 14 while allowing the distal jaw section 17 to subsequently travel upward and align with the upper jaw 16 upon closure of the opposing jaws 13. Accordingly, the recessed portion 32 facilitates proper distal alignment of the opposing jaws 13 during rotational movement while maintaining a compact jaw profile.

In some embodiments, at least one of the opposing jaws includes an over-molded elastomeric sleeve 30 or a textured surface 31 to enhance frictional engagement when manipulating small or smooth objects. In embodiments including an over-molded elastomeric sleeve 30, the sleeve 30 may comprise silicone, thermoplastic elastomer (TPE), rubber, or other compliant material configured to enhance frictional engagement. The textured surface 31 may be formed integrally with the jaw structure, e.g., formed as teeth 31a, or provided as a separate gripping layer. These material selections permit a balance between structural rigidity, weight reduction, and compliant gripping performance.

In certain embodiments, at least one of the upper jaw 16 and the lower jaw 15 includes a jaw main body 14 and a distal jaw section 17 at a distal end 17a thereof.

In some embodiments, the opposing upper jaw 16 and lower jaw 15 define opposing contact surfaces that are configured and toleranced to be in continuous contact along at least a portion of respective lengths of the opposing upper jaw 16 and lower jaw 15 between the pivot joint 4 and the respective upper jaw 16 and lower jaw 15 termini at the distal jaw section 17, the contact configured to serve as a torque limiter to prevent over gripping of the distal jaw section 17 on a target object.

The distal jaw section 17 may have a reduced cross-sectional portion 18 relative to the jaw main body 14. A removable distal gripping module 37 may be mounted over the distal jaw section 17. The removable distal gripping module 37 may comprise a discrete body separable from the distal jaw section 17 and may include an internal cavity 39 configured to receive the distal jaw section 17. The removable distal gripping module 37 may be formed from polymeric material, elastomeric material, composite material, or combinations thereof. The removable distal gripping module 37 may alter the distal gripping geometry of the corresponding jaw 15, 16. Whether integral to jaws 15, 16 or as separable distal grip modules 37, alternative geometries may be provided to facilitate retention of wires, screws, beads, or other small components. For example, in certain embodiments, at least one of the opposing jaws 13, or the distal grip module 37, includes a plurality of gripping projections as the textured surface 31. The textured surface 31 may define alternating ridges and recesses extending transversely across the width of the jaws 15, 16. In some configurations, the recesses are defined by arcuate or semi-circular concave surfaces sized to receive at least a portion of a cylindrical object. Termed herein “arcuate recesses”, the plurality of arcuate recesses defining the textured surface 31 may be longitudinally spaced along the distal gripping edge such that, upon closure of the upper jaw 16 and the lower jaw 15, opposing recesses cooperate to partially surround and stabilize the cylindrical fastener. The textured surfaces 31 may be formed integrally with jaw main body 14, distal jaw section 17, or removable distal gripping module 37.

In embodiments utilizing the removable distal gripping module 37, the textured surface 31 may be molded or formed as part of the discrete body of the removable distal gripping module 37. As above, the arcuate recess geometry may be configured to retain screws, nails, wires, pins, or similar elongated members by partially cradling the object within opposing concave surfaces. In certain embodiments, the removable distal gripping module 37 includes one or more distal edge surfaces 43 as shown. The distal edge surfaces 43 define the primary geometry of the corresponding distal ends 17a of the upper jaw 16 or lower jaw 15. Distal pins 41 and distal pin holes 42 may cooperate to provide positional alignment and mechanical retention of the removable distal gripping module 37 relative to the distal jaw section 17. The engagement between the distal pins 41 and distal pin holes 42 may provide resistance to rotational movement, axial displacement, or both.

The distal edge surfaces 43 may assume a variety of geometries depending on the intended gripping or use application. In some embodiments, the edge surfaces 43 are substantially planar and extend transversely across the width of the distal gripping module 37 to provide broad contact engagement. In other embodiments, the distal edge surfaces 43 are rounded or arcuate in profile to facilitate controlled engagement of small or delicate objects. In further embodiments, the distal edge surfaces 43 may be slanted or inclined relative to a longitudinal axis of the distal jaw section 17. Such inclined geometries may assist in guiding an object into a gripping region upon closure of the opposing jaws 13. In additional embodiments, the distal edge surfaces 43 may be formed as a scoop configuration, including a concave surface extending proximally from a distal edge. The scoop configuration may partially cradle an object during closure of the opposing jaws 13 to enhance positional stability. The geometry of the distal edge surfaces 43 may vary between the upper jaw 16 and the lower jaw 15 and may be symmetrical or asymmetrical.

The distal edge surfaces 43 may be integrally formed with jaw main body 14 or distal jaw section 17 or may be formed as part of the removable distal gripping module 37. In embodiments utilizing the removable distal gripping module 37, different edge surface geometries 43 may be selectively interchanged to adapt the gripping device 1 to different object types. The distal edge surfaces 43 may be formed from rigid material, elastomeric material, or combinations thereof, and may include over-molded compliant layers to enhance frictional engagement.

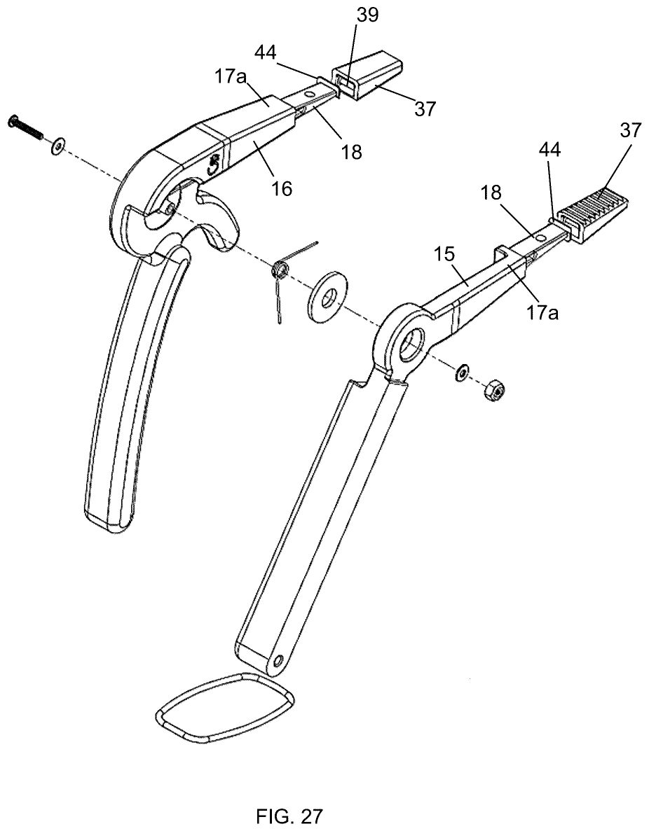

In certain embodiments, referencing FIG. 27, distal jaw section 17 includes a reduced cross-section portion 18 defining distal end 17a but which has a longer length. Here, reduced cross-sectional portion 18 extends more distally and includes a terminal raised lip 44 formed proximate to distal end 17a. The raised lip 44 may define a localized increase in cross-sectional dimension relative to the reduced cross-sectional portion 18 and may form a retaining shoulder at this distal terminus of distal jaw section 17. The raised lip 44 may be formed integrally with distal jaw section 17 during molding or machining and may include a radiused, chamfered, stepped, or tapered profile. The raised lip 44 cooperates with a corresponding internal surface of removable distal gripping module 37 to provide supplemental retention of a target object when engaged with the distal jaw section 17. In this embodiment, internal cavity 39 of removable distal gripping module 37 may include a complementary recess, step, or engagement surface configured to engage the raised lip 44.

In some embodiments, a magnet seat 35 may be formed on an outer surface 36 of the upper jaw and may be configured to magnetically retain small metallic objects.

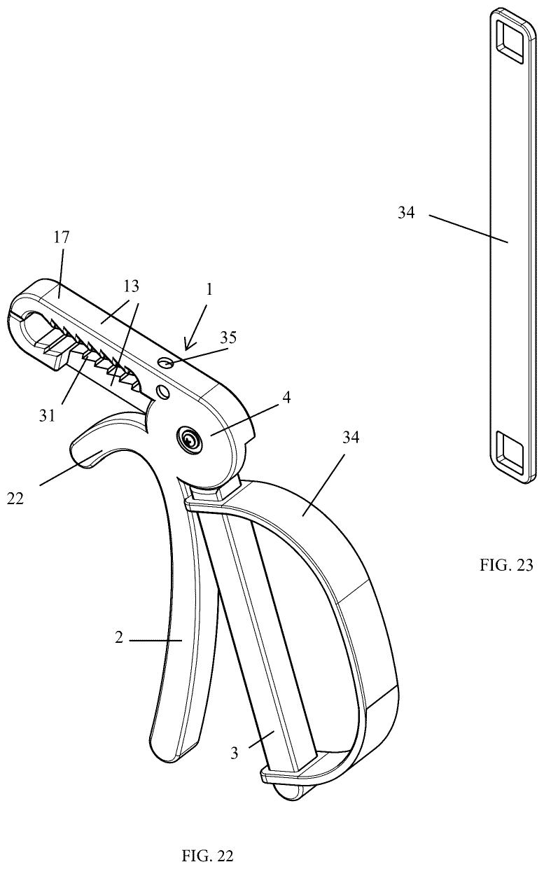

In some embodiments, an assistive cuff 34 (see FIGS. 22-23) may be coupled to at least one of the forward handle member 2 and the rear handle member 3 and may be configured to receive a portion of a user's hand to stabilize actuation. As shown, a flexible retention loop 38 may extend between the forward handle member 2 and the rear handle member 3 to maintain the opposing jaws in a closed position. The flexible retention loop 38 may be adapted to pass through and be retained by a through-hole 40 defined at a lower rear portion 3a of the rear handle member 3 and may be configured to wrap around a lower handle portion 2b of the forward handle member 2.

In use, compact and lightweight composition permits direct hand positioning of a user adjacent the opposing jaws 13 and enhances stability during manipulation of small objects.

While specific embodiments have been described, it will be understood that variations and modifications may be made without departing from the scope of the appended claims.

What is claimed is:

1. A gripping device, comprising:
a forward handle member;
a rear handle member;
wherein said rear handle member is substantially linear and said forward handle member includes an ergonomic curvature,
a pivot joint joining said forward handle member and said rear handle member, said pivot joint defining a pivot axis;
a biasing member disposed about the pivot joint, said biasing member configured to bias said forward handle member and said rear handle member toward a normally open position; and,
opposing jaws extending distally from respective ones of said forward handle member and said rear handle member defining a longitudinal jaw axis, said longitudinal jaw axis forming an obtuse angle relative to a longitudinal axis of said forward handle member and said rear handle member, wherein a lower jaw of said opposing jaws includes a recessed portion defined in a lateral surface thereof, wherein said recessed portion cooperates with said pivot joint to accommodate rotational movement of said lower jaw such that a distal jaw section aligns with an upper jaw when said forward handle member and said rear handle member are compressed.

2. The gripping device of claim 1, wherein an inner surface of said rear handle member includes an inwardly projecting raised portion configured to abut an opposing interior surface of said forward handle member to limit closure.

3. The device of claim 1, further comprising a finger hook extending integrally from said forward handle member between said pivot joint and a lower jaw of said opposing jaws to guide pinch-type actuation, wherein said finger hook is defined by a curved profile, said curved profile having opposite concavity relative to said ergonomic curvature of said forward handle member.

4. The device of claim 1, wherein said biasing member comprises a torsion spring, said torsion spring concentrically disposed about said pivot axis such that a spring axis of said torsion spring is coaxial with said pivot axis.

5. The device of claim 4, wherein said pivot joint further comprises:
a fastener extending through aligned apertures of said forward handle member and said rear handle member;
a first washer positioned adjacent a head of said fastener;
a second washer positioned adjacent a nut secured to said fastener; and,
a third washer disposed proximate to said torsion spring between said forward handle member and said rear handle member, said third washer being concentrically positioned about said fastener and positioned such that said third washer is abutting said torsion spring within said pivot joint, said fastener applying axial compression to retain said torsion spring and said third washer in fixed axial alignment between said forward handle member and said rear handle member.

6. The device of claim 1, wherein said opposing jaws comprise substantially flat gripping surfaces configured for precision manipulation of small objects.

7. The device of claim 1, wherein at least one of said opposing jaws includes an over-molded elastomeric sleeve.

8. The device of claim 1, wherein at least one of said opposing jaws includes a textured surface.

9. The device of claim 1, wherein said recessed portion is centrally positioned within a jaw body and extending longitudinally along at least a part of said jaw body.

10. The device of claim 1, further comprising an assistive cuff coupled to either said forward handle member or said rear handle member configured to receive a portion of a user's hand to stabilize actuation of said device.

11. The device of claim 1, further comprising a magnet seat formed on an outer surface of said upper jaw configured to magnetically retain small metallic objects.

12. The device of claim 1, wherein at least one of said upper jaw and said lower jaw includes a shaped geometry configured to retain wires or screws.

13. The device of claim 1, further comprising a removable distal gripping module on at least one of said upper jaw and said lower jaw.

14. The device of claim 1, further comprising a flexible retention loop extending between said forward handle member and said rear handle member configured to maintain said opposing jaws in a closed position.

15. A gripping device, comprising:
a forward handle member;
a rear handle member;
a pivot joint joining said forward handle member and said rear handle member;
a biasing member disposed about said pivot joint and configured to bias said forward handle member and said rear handle member toward a normally open position;
opposing jaws extending distally from respective ones of said forward handle member and said rear handle member, said opposing jaws including an upper jaw and a lower jaw,
wherein at least one of said upper jaw and said lower jaw includes a jaw main body and distal jaw section at a distal end thereof, said distal jaw section having a reduced cross-sectional portion relative to said jaw main body; and
a removable distal gripping module mounted over said reduced cross-sectional portion, said removable distal gripping module comprising a discrete body separable from said distal jaw section and including an internal cavity configured to receive said distal jaw section.

16. The device of claim 15, wherein said removable distal gripping module includes at least one distal edge surface, said distal edge surface defining an object-engagement geometry at said distal end; wherein said distal edge surface is selected from the group consisting of a planar surface, a rounded surface, an inclined surface and a concave scoop surface.

17. The device of claim 15, wherein said distal jaw section includes a raised lip formed at a distal terminus of said reduced cross-sectional portion, said raised lip configured to engage an internal surface of said removable distal gripping module to limit axial displacement.

18. A gripping device, comprising:
a forward handle member having a lower handle portion;
a rear handle member having a lower rear portion;
a pivot joint joining said forward handle member and said rear handle member;
a torsion spring concentrically disposed about a pivot axis of said pivot joint and configured to bias said forward handle member and said rear handle member toward a normally open position;
opposing jaws extending distally from respective ones of said forward handle member and said rear handle member;
wherein an inner surface of said rear handle member includes an inwardly projecting raised portion configured to abut an opposing inner surface of said forward handle member to limit rotational closure;
wherein said forward handle member includes an ergonomic curvature; and
wherein a finger hook extends integrally from said forward handle member between said forward handle member and a lower jaw of said opposing jaws, said forward handle member includes an arcuate body portion positioned between said pivot joint and said lower jaw, said arcuate body portion defining a concave inwardly facing contour and forming a structural base from which said finger hook extends, said finger hook having a curved profile with opposite concavity relative to said ergonomic curvature of said forward handle member.

19. The device of claim 18, wherein at least one of said opposing jaws includes a recessed portion defined in a lateral surface thereof, said recessed portion being centrally positioned within a jaw body and extending longitudinally along at least a part of said jaw body.

20. The device of claim 18, further comprising a flexible retention loop extending between said forward handle member and said rear handle member configured to maintain said opposing jaws in a closed position, said flexible retention loop adapted to pass through and be retained by a through hole defined at said lower rear portion and wherein said flexible retention loop can removably wrap around and retain said lower handle portion.
